(19) United States
(12) Patent Application Publication
(10) Pub. No.: US 2013/0215280 A1
(43) Pub. Date: Aug. 22, 2013

(54) CAMERA CALIBRATION DEVICE, CAMERA AND CAMERA CALIBRATION METHOD

(71) Applicants: Takashi MAEKAWA, Yokohama-shi (JP); Haruo YANAGISAWA, Setagaya-ku (JP); Ryuuichi SAWADA, Setagaya-ku (JP)

(72) Inventors: Takashi MAEKAWA, Yokohama-shi (JP); Haruo YANAGISAWA, Setagaya-ku (JP); Ryuuichi SAWADA, Setagaya-ku (JP)

(73) Assignee: KYOCERA CORPORATION, Kyoto (JP)

(21) Appl. No.: 13/564,612

(22) Filed: Aug. 1, 2012

(30) Foreign Application Priority Data
Sep. 13, 2011 (JP) 2011-200005
Feb. 24, 2012 (JP) 2012-039417

(51) Int. Cl. H04N 17/00

(52) U.S. Cl. CPC H04N 17/004
USPC 348/187

(57) ABSTRACT

An object of the present invention is to provide a camera calibration device, enabling a single operation of camera calibration by using a calibration index, a camera and a camera calibration method. A camera calibration device (100) includes an imaging unit (1) configured to take an image of a calibration index (8), an instruction means (5) configured to instruct on a display position of a calibration marker (14) to be superimposed on the image, an image signal processing means (3) configured to process the image such that the calibration marker is superimposed at the display position according to the instruction, and a calculation unit (4) configured to calculate a camera mounting angle based on the display position of the calibration marker (14) displayed overlapping two points of the calibration index (8).

### CROSS REFERENCE TO RELATED APPLICATION

This application claims priority to and the benefit of Japanese Patent Application No. 2011-200005 filed on Sep. 13, 2011 and Japanese Patent Application No. 2012-039417 filed on Feb. 24, 2012, the entire contents of which are incorporated herein by reference.

### FIELD OF THE INVENTION

The present invention relates to a camera calibration device, a camera and a camera calibration method for calibrating a camera mounting angle on a movable object (vehicle) by calculating the camera mounting angle by taking an image of a calibration index.

### BACKGROUND OF THE INVENTION

In recent years, various vehicles including cars often have onboard cameras for assisting drive by supplementing drivers' views. An image taken by the onboard camera is displayed in, for example, a display such as a navigation device to allow a driver to view. As necessary, graphic data indicating a predicted track may be superimposed on the displayed image. When a rear-view camera is mounted for supplementing a rear view of the vehicle, for example, the graphic data indicating the predicted track based on a steering angle when the vehicle is moving backward may be superimposed on the image in real time.

Such an onboard camera is mounted on the vehicle by workers and, generally, a mounting accuracy is substantially low. A display position of the graphic data superimposed on the image taken by the onboard camera is susceptible to the mounting accuracy of the onboard camera. Therefore, when the mounting accuracy is very low, the display position of the graphic data is greatly displaced from an original position, providing the driver with incorrect information. In using such an onboard camera, accordingly, the mounting angle of the onboard camera is calibrated by calculating the mounting angle by taking an image of the calibration index provided outside the vehicle and evaluating a display position of the calibration index in the image.

Generally, a three-dimensional object has been used as the calibration index for calibration of the onboard camera. However, in consideration of simplicity and productivity for the workers and worksites for performing calibration, Patent Document 1 discloses an example of a calibration method using, instead of the three-dimensional object, a two-dimensional index placed on a plane as the calibration index. According to Patent Document 1, when an image of the two-dimensional index is taken by the onboard camera, an operator superimposes a window, whose display position is movable, on the image and adjusts the display position of the window to accommodate the calibration object therein. Thereby, parameters necessary for calibration (a roll angle, a pan angle and a tilt angle of the onboard camera) are calculated. According to Patent Document 1, the display position of the window is controlled through a user interface.

### RELATED ART DOCUMENT

### Patent Document

Patent Document 1: Japanese Patent Laid-Open No. 2001-245326

### SUMMARY OF THE INVENTION

According to Patent Document 1 described above, since a display position of a window 23 is adjusted by rotating the window 23 clockwise and counterclockwise as well as by moving in horizontal and vertical directions, the user interface for instructing on the display position of the window 23 is intricately configured and imposes a work load on the operator. Also, it is difficult for the operator to accurately place a calibration index 22 inside the window 23 in one adjustment operation and the operator needs to repeat adjustment several times. Therefore, there is a problem that the operator needs to be skilled in adjustment and also to bear a heavy work load.

Accordingly, it is an object of the present invention, in consideration of such a problem, to provide a camera calibration device, a camera and a camera calibration method enabling a simple operation of camera calibration by using the calibration index.

In order to solve the above problem, a camera calibration device according to one embodiment for calibrating a camera mounting angle on a movable object by calculating the camera mounting angle by taking an image of a calibration index, includes: an imaging unit configured to take the image including the calibration index having two separate points on a plane; an image superimposing unit configured to process an image signal such that a calibration marker is superimposed on the image; an instruction unit configured to instruct on a position to superimpose the calibration marker in the image; and a calculation unit configured to calculate the camera mounting angle based on a display position of the calibration marker when the calibration marker is superimposed overlapping the two points of the calibration index.

The camera calibration device according to the embodiment enables, without a complex operation such as repetitive fine adjustments, to easily adjust the display position of the calibration marker so as to overlap the two points of the calibration index and to calculate the camera mounting angle, for camera calibration. Especially, since the display position of the calibration marker may be adjusted by simply shifting the calibration marker in vertical and horizontal directions without rotating, the work load imposed on the operator is reduced and easy calibration is enabled.

A rear camera employs a wide angle lens to obtain a wide view of an image taking area. Such a wide angle lens has a significant distortion and may cause deformation of a subject image especially near a periphery thereof. In such a case, with the technique of Patent Document 1 described above, an image of the calibration object 22 in the image taken by the camera is significantly deformed and possibly protrude from the window 23. According to the present embodiment, in contrast, the calibration marker is simply shifted to overlap the two points of the calibration index. Therefore, when the wide angle lens is used for the imaging unit, the calibration marker may be easily and accurately shifted to the position of the calibration index.

According to the embodiment, also, a calculation amount for displaying the calibration marker in a display panel in real time during calibration may be reduced. According to the embodiment, that is, the calibration marker is linearly shifted in the vertical and horizontal directions on the image in calibration and calibration data are calculated collectively after such positional adjustment Unlike Patent Document 1 described above, therefore, a special calculation is not necessary for displaying the calibration marker in real time on the image, which reduces processes for calibration and the calibration marker may be displayed in the display panel immediately.

Preferably, the calibration marker is shifted in the vertical and horizontal directions. Thereby, the calibration marker does not need to be rotated and calibration is simplified, reducing a risk of erroneous operations and a time necessary for calibration.

Preferably, two calibration markers are displayed on the image so as to correspond to two separate points of the calibration index and display positions of the calibration markers may be separately controlled by an instruction means. Since the display positions of the two calibration markers may be separately controlled on the image, the operator may easily place each of the calibration markers over the two points of a structure index.

Preferably, the calibration marker is formed of two lines orthogonal to each other and an intersection of the two lines indicates the display position of the calibration marker. Thereby, a size of the calibration marker is increased, allowing the operator to easily recognize the calibration marker in the display panel such as a display and improving operability. Especially, since the intersection indicates the display position of the calibration marker, the operator may instinctively recognize an exact display position of the calibration marker and shift the calibration marker precisely to overlap the two points of the calibration index.

The calibration marker may be in a shape surrounding a predetermined area, and the calculation unit may calculate the camera mounting angle based on the display position of the calibration marker when the calibration marker is displayed overlapping the two points of the calibration index. Since the camera mounting angle may be calculated when the calibration marker does not completely overlap the calibration index, the calibration marker in the shape surrounding the predetermined area enables to further reduce an operation time.

Preferably, the calibration index is formed of a line connecting the two separate points. In this case, since the two points are at ends of the calibration index, the operator may instinctively and easily recognize the two points of the calibration marker.

The image superimposing unit may highlight the calibration marker being shifted. Thereby, the calibration marker being shifted may be clearly distinguished from a plurality of calibration markers and thus operability of the user may be improved.

The image taken by the camera is output, after the calculation unit calculates parameters, being offset by an amount corresponding to the parameters.

Alternatively, the image taken by the camera is output, after the calculation unit calculates the parameters, being offset by the amount corresponding to the parameters, or the image superimposing unit, when superimposing a predetermined image on the image taken by the camera, sets an offset for a superimposing position by the amount corresponding to the parameters. Thereby, when an image of a predicted track and the like is superimposed, the image is superimposed offset from an original superimposing position before calibration parameters are calculated. Accordingly, a highly accurate predicted vehicle track may be displayed in parking, for example.

The camera calibration device may further include a display for displaying an image in which the calibration marker is superimposed on the image including the calibration index. Further, the camera calibration device may be constituted, without the imaging unit, by using: an image superimposing unit configured to process an image signal such that the calibration marker is superimposed on the image including the calibration index having two separate points on a plane; an instruction unit configured to instruct on a display position of the calibration marker superimposed on the image; and a calculation unit configured to calculate the camera mounting angle based on the display position of the calibration marker when the calibration marker is superimposed on the image overlapping the two points of the calibration index.

In order to solve the above problem, a camera calibration method according to one embodiment for calibrating a camera mounting angle on a movable object by calculating the mounting angle by taking an image of a calibration index, includes: a step to take an image including the calibration index having two separate points on a plane; a step to superimpose a calibration marker on the image; a step to instruct on a display position of the calibration marker superimposed on the image; and a step to calculate the camera mounting angle based on the display position of the calibration marker superimposed overlapping the two points of the calibration index.

The camera calibration method according to the embodiments may be appropriately substantialized by the calibration device described above (included in each embodiment).

Also, a camera according to one embodiment, capable of calibrating a camera mounting angle on a movable object by calculating the camera mounting angle by taking an image of a calibration index, includes:

an imaging unit configured to take an image including the calibration index having two separate points on a plane;

an image superimposing unit configured to process an image signal such that a calibration marker is superimposed on the image; and

an instruction reception unit configured to receive an instruction on a display position of the calibration marker superimposed on the image, wherein

the camera mounting angle is calculated based on the display position of the calibration marker when the calibration marker is displayed overlapping the two points of the calibration index.

The camera according to the embodiments may be appropriately substantialized by having the calibration device (included in each embodiment) described above.

### BRIEF DESCRIPTION OF THE DRAWINGS

FIG. 1 is a block diagram illustrating an entire configuration of a camera calibration device according to one embodiment of the present invention.

FIG. 2 is a diagram illustrating examples of operation units of an instruction unit serving as a user interface.

FIGS. 3(a) and (b) are diagrams illustrating variations of a form of a calibration index imaged by an imaging unit in calibration.

FIG. 4 is a flowchart illustrating control by a CPU in steps.

FIG. 5 is a flowchart illustrating a shift operation of a calibration marker according to the present invention.

FIGS. 6(a)-(e) are diagrams illustrating an example of a shift of the calibration marker by the camera calibration device according to one embodiment of the present invention.

FIG. 7 is a diagram illustrating a positional relationship between the imaging unit provided to a vehicle and the calibration index.

FIGS. 8(a)-(c) are diagrams illustrating examples of rotation in a world coordinate system.

FIGS. 9(a)-(b) are diagrams illustrating examples of the calibration marker.

FIG. 10 is a diagram illustrating a movable object having a camera mounted thereon.

### DETAILED DESCRIPTION OF EMBODIMENTS OF THE INVENTION

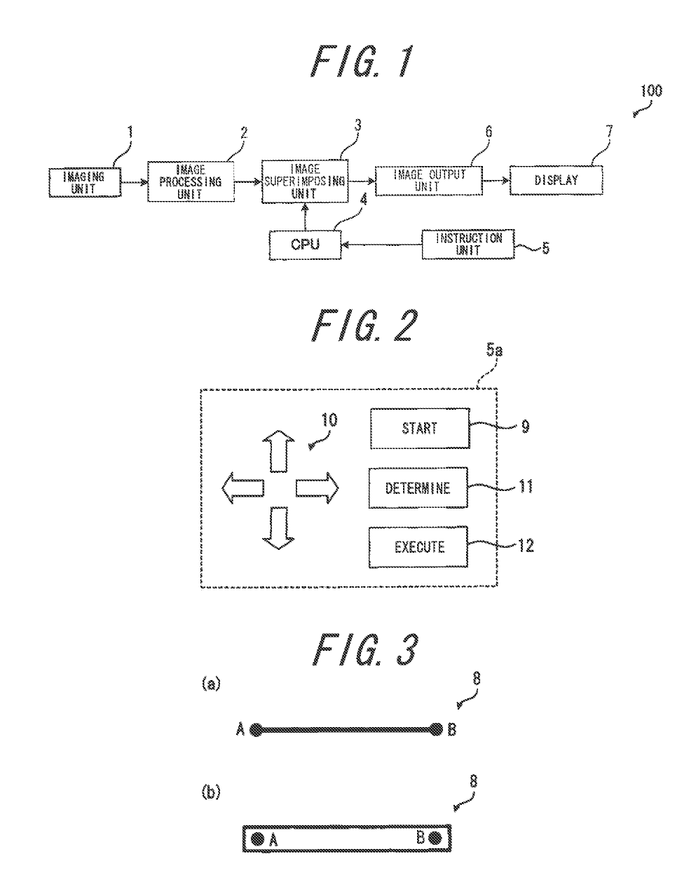

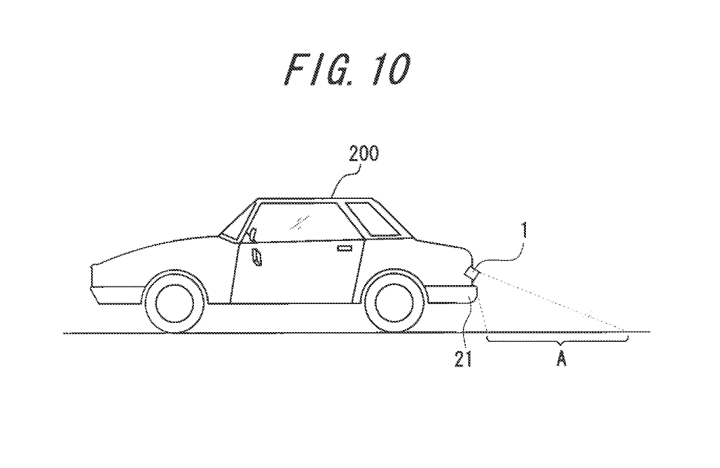

FIG. 1 is a block diagram illustrating an entire configuration of a camera calibration device 100 according to one embodiment. An imaging unit 1 serving as a camera (an onboard camera) mounted on a movable object (vehicle) has an image sensor such as CMOS or CCD for converting the light of a subject entering through a lens (not illustrated) into an electric signal. FIG. 10 is a diagram illustrating the movable object having the imaging unit 1 mounted thereon. According to the present embodiment, as illustrated in FIG. 10, the imaging unit 1 is mounted near a rear bumper 21 of a movable object 200 to take an image behind the movable object 200. An area A in the figure represents an area captured by the imaging unit 1.

A display 7, when a user selects a parking mode, displays an image generated by the camera calibration device 100. The parking mode assists smooth parking by displaying, on the display 7, an image in the area A behind the movable object 200 where it is difficult for the user driving the movable object 200 to view. A predicted track of the movable object 200 may be superimposed on the image in the area A behind the movable object 200, for assisting smoother parking.

Also, when the user selects a camera calibration mode, the image generated by the camera calibration device 100 is displayed. The camera calibration mode, by disposing a subject or figure serving as an index in the area A behind the movable object 200, allows the user to calibrate a mounting position of the imaging unit 1 by using an image of the index taken by the imaging unit 1. The camera calibration mode is used when the imaging unit 1 is mounted on the movable object 200 in a production line of the movable object 200 or when the imaging unit 1 is displaced due to vibrations of the movable object 200 or the like. A calibration method will be described in detail below.

When a navigation mode is selected by the user, the display 7 may display a route map to a destination obtained by a navigation system. When a TV mode is selected, the display 7 may display television obtained by a TV receiver.

An image processing unit 2, by processing the electric signal output from the imaging unit 1, generates an image signal for displaying a digital image in, for example, a progressive form or an interlace form.

An image superimposing unit 3, such that a calibration marker used in calibration described below or the predicted track followed by the movable object moving backward is superimposed as graphic data at a predetermined position on the image taken by the imaging unit 1, processes the image signal input from the image processing unit 2.

Display of the calibration marker superimposed on the image is controlled according to an instruction by a CPU (calculation unit) 4. Especially, a display position of the calibration marker is controlled by the CPU 4 via an instruction unit 5 serving as a user interface that may be operated by an operator. The instruction unit 5 has an operation unit 5a that allows an input of an instruction to shift the display position of the calibration marker on the image.

Note that a configuration of the camera of the camera calibration device is not particularly limited and may include, for example, the imaging unit 1, the image processing unit 2, the image superimposing unit 3, the CPU 4 and an image output unit 6.

FIG. 2 illustrates an example of the operation unit 5a of the instruction unit 5 serving as the user interface. The operation unit 5a includes a start button 9 operated at the start of calibration, a shift button 10 for moving the calibration marker in vertical and horizontal directions, a position determination button 11 operated at the end of shift of the calibration marker, and an execution button 12 operated for executing calibration. However, the operation unit 5a is not limited to the example illustrated in FIG. 2 but may be, for example, a mouse, a keyboard, a joystick or a touch panel. Also, the buttons set forth above may be mechanical switches or objects displayed on the touch panel laminated on the display 7.

Referring back to FIG. 1, the image having the calibration marker superimposed thereon by the image superimposing unit 3 is converted by the image output unit 6 into the image signal in a format (for example, NTSC or the like) appropriate for display. Then, when the converted image signal is input to the display 7 serving as a display means, the image is displayed on a screen.

A calibration index 8 is the subject or figure disposed at a predetermined distance (for example, 1 m) from a rear edge of the movable object 200 when the movable object 100 is accurately stopped at a predetermined parking position, and takes the shape of, for example, a rectangular plate or a white line drawn on a road. That is, when the camera is mounted at a correct angle, a positional relationship between the movable object 200 and the calibration index 8 is specified, thus the calibration index 8 taken by the imaging unit 1 is always displayed at a particular position in the image displayed on the display 7. When the calibration index 8 is displayed off the particular position, calibration parameters for specifying deviation of a mounting angle of the imaging unit 1 may be obtained by shifting the calibration marker to the calibration index 8 by using the instruction unit 5.

FIG. 3 is a diagram illustrating variations of a form of the calibration index 8 imaged by the imaging unit 1 in calibration. The calibration index 8 according to the present embodiment has two points A and B having a predetermined distance therebetween on a plane.

In an example in FIG. 3(a), the calibration index 8 is formed of a line connecting the two points A and B on the plane. Since the calibration object 8 has the points A and B at the ends of the line, the operator may easily recognize the calibration index 8 displayed in the display 7. Although both ends of the index 8 have a black dot denoting the point A or B in FIG. 3(a), these dots are not necessary and the line may be thicker for easy recognition by the operator. As illustrated in FIG. 3(b), also, the calibration index 8 may be in the form of a frame including the points A and B at both edges thereof.

Although the calibration index 8 according to the present embodiment may take a variety of forms, the calibration index 8 having the form illustrated in FIG. 3(a) (the line without the dots at both ends thereof) is used as an example in the description below.

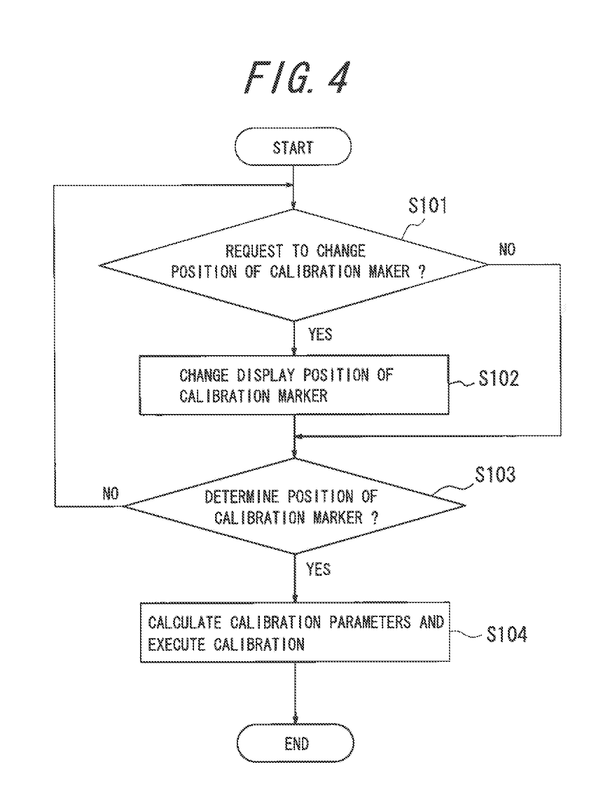

Now, control by the CPU 4 will be described in detail referring to FIG. 4. FIG. 4 is a flowchart illustrating the control by the CPU 4 in steps.

First, the CPU 4 determines whether the instruction unit 5 is requested to change the display position of the calibration marker for calibration (step S101), by detecting an operation of the start button 9 of the operation unit 5a of the instruction unit 5 by the operator.

When the operation of the start button 9 is detected, the CPU 4 then detects which one of the shift button 10 corresponding to shift in the vertical direction or in the horizontal direction is operated by the operator (step S101) and, based on the direction of the shift button operated, shifts the display position of the calibration marker (step S102). Such operation to shift the calibration marker is performed in real time by the operator viewing the display position of the calibration marker in the panel of the display 7. When there is no request at step S101 (No at step S101), the CPU 4 proceeds to step S103 described below skipping the process at step S102.

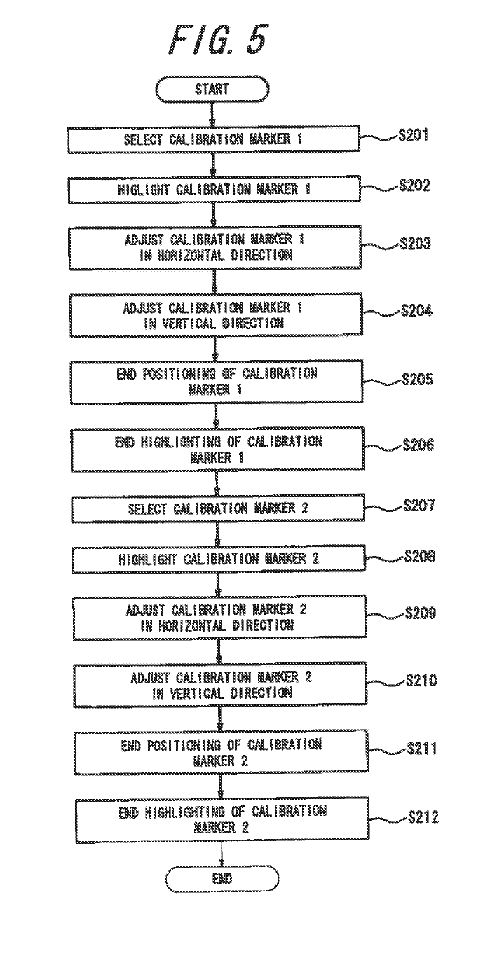

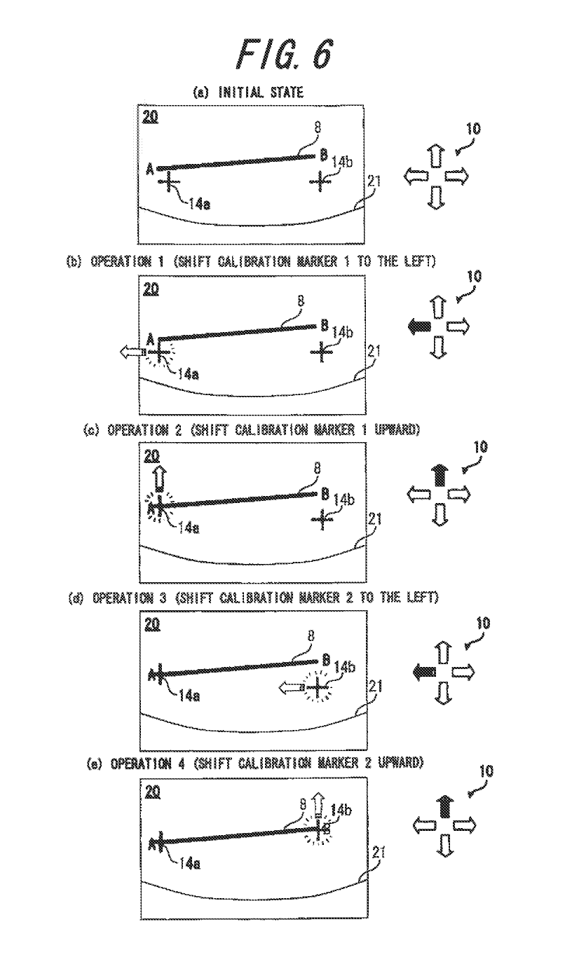

FIG. 5 is a flowchart illustrating an operation to shift the calibration marker at step S102. FIG. 6 is a diagram illustrating an example of a shift of the calibration marker by the camera calibration device 100 according to the present embodiment. Referring to FIGS. 5 and 6, the calibration using the calibration marker will be described. Preferably, the image superimposing unit 3, in order to improve operability of the user by clearly indicating calibration markers 14a and 14b shifted, highlights one of the calibration markers being shifted (selected). The calibration marker is highlighted by, for example, blinking or changing color or a thickness thereof, to allow distinguish from another calibration marker not being shifted (unselected). In the example illustrated in FIGS. 5 and 6, the calibration marker is highlighted.

FIG. 6(a) illustrates an initial state where the image (including a rear bumper 21 of the movable object having the camera calibration device 100 mounted thereon and the calibration index 8 provided on the road behind the movable object) taken by the imaging unit 1, and the calibration markers 14a and 14b are displayed in a display panel 20.

The calibration markers 14a and 14b correspond to the calibration index 8 displayed in the display 7 and the display positions of the calibration markers 14a and 14b may be separately controlled by operation of the shift button 10 of the index unit 5. Since the display positions of the calibration markers 14a and 14b on the image may be separately controlled, the operator may easily operate to place the calibration markers 14a and 14b to overlap the two points A and B of the calibration index 8.

When a single pressing of the shift button 10 is made correspond to offset at 0.5 degree, the calibration markers 14a and 14b, upon a single pressing of the shift button 10 for shifting the calibration markers in the horizontal direction, are shifted by the number of pixels equivalent to a shift amount of the image when an image taking direction of the camera is directed by 0.5 degree in a pan (horizontal) direction. The same applies to a tilt (vertical) direction.

First, the operator selects the calibration marker 14a, between the calibration markers 14a and 14b, displayed on the left side in the display panel (step S201). When the calibration marker 14a is selected at step S101, the image superimposing unit 3 highlights the calibration marker 14a to be shifted, for easy distinguishing from the calibration marker 14b not to be shifted (step S202). FIGS. 6(b) and (c) illustrate a state that the calibration marker 14a is blinking (highlighted).

The operator, by operating the shift button 10 corresponding to a left direction, shifts the calibration marker 14a in the left direction as illustrated in FIG. 6(b) such that the calibration marker 14a meets a coordinate of the left end A of the calibration object 8 in the horizontal direction (step S203). Subsequently, the operator, by operating the shift button 10 corresponding to an upward direction, shifts the calibration marker 14a upward as illustrated in FIG. 6(c) such that the calibration marker 14a meets a coordinate of the left end A in the vertical direction (step S204). When the coordinates of the left end A of the calibration index 8 meet coordinates of the calibration marker 14a, the operator instructs to end positioning of the calibration marker 14a (step S205). The operator may instruct to end positioning by, for example, holding the shift button 10 down or pressing the shift button 10 twice (double click). Alternatively, an instruction end button is provided to the instruction unit 5a for allowing the operator to operate to end positioning. Upon receiving the instruction to end positioning from the instruction unit 5, the CPU 4 controls the image superimposing unit 3 to end highlighting (step S206).

Next, the operator selects the calibration marker 14b, between the two calibration markers, displayed on the right side in the display panel (step S207). Alternatively, the CPU 4 may automatically select the calibration marker 14b upon receiving the instruction to end positioning of the calibration marker 14a from the instruction unit 5. When the calibration marker 14b is selected at step S207, the image superimposing unit 3 highlights the calibration marker 14b to be shifted, for distinguishing from the calibration marker 14a not to be shifted (step S208). FIGS. 6(d) and (e) illustrate a state that the calibration marker 14b is blinking (highlighted).

The operator, in a similar manner for shifting the calibration marker 14a described above, operates the shift button 10 corresponding to the left direction as illustrated in FIG. 6(d) such that the calibration marker 14b meets a coordinate of the right end B of the calibration index in the horizontal direction (step S209). Subsequently, the operator, by operating the shift button 10 corresponding to the upward direction, shifts the calibration marker 14b upward as illustrated in FIG. 6(e) such that the calibration marker 14b meets a coordinate of the right end B of the calibration index in the vertical direction (step S210). When the coordinates of the right end B of the calibration index 8 meets coordinates of the calibration marker 14b, the operator instructs to end positioning of the calibration marker 14b (step S211). The operator may instruct to end positioning by, for example, holding the shift button 10 down or pressing the shift button 10 twice (double click). Alternatively, the instruction end button is provided to the instruction unit 5a for allowing the operator to operate to end positioning. Upon receiving the instruction to end positioning from the instruction unit 5, the CPU 4 controls the image superimposing unit 3 to end highlighting (step S212).

As described above, the camera calibration device 100 according to the present embodiment may adjust the calibration markers 14a and 14b so as to overlap the two points A and B of the calibration index 8 simply by shifting the calibration markers 14a and 14b in the vertical and horizontal directions on the image. That is, since a complex adjustment such as rotation of the calibration marker according to background arts is not necessary, repetitive adjustment of the position of the calibration marker is eliminated, thereby effectively reducing a work load imposed on the operator in operation. Also, the shift button 10 of the operation unit 5 of the instruction unit 5 may be simplified as a rotating operation is not necessary, which is excellent in terms of cost reduction.

Referring back to FIG. 4, the CPU 4 determines whether shift of the display positions of the calibration markers 14a and 14b is finished (step S103), based on whether the position determination button 11 of the operation unit 5a is operated by the operator. When the operator operates the execution button 12, calibration parameters (a roll angle, a pan angle and a tilt angle of the camera) are calculated based on the determined display positions of the calibration markers 14a and 14b, and calibration is executed (step S104). When the positions of the calibration markers 14a and 14b are not determined at step S103 (NO at step S103), the CPU returns to step S101 to repeat the process described above.

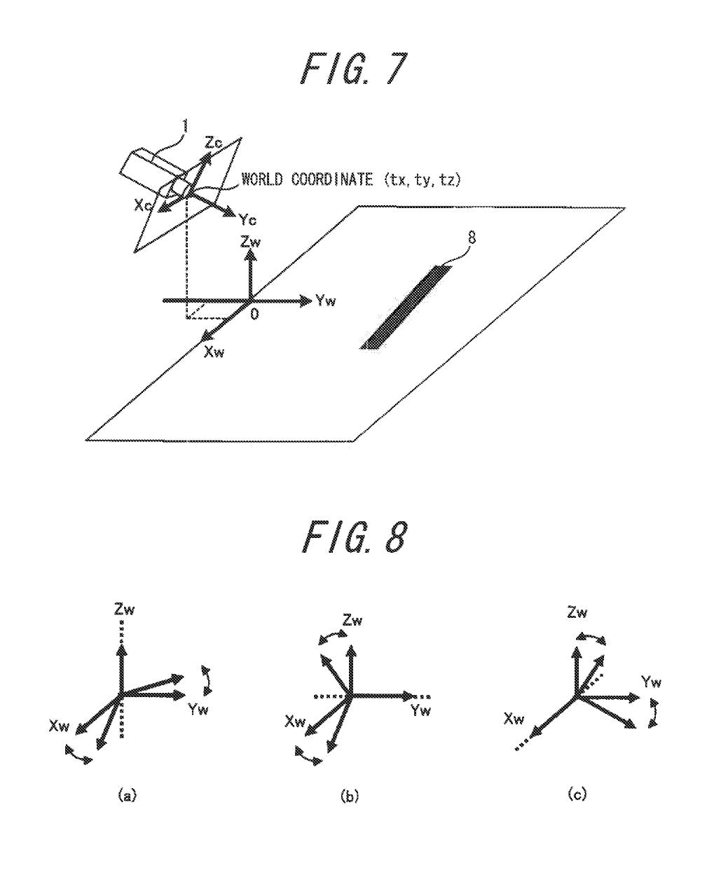

Next, a method for calculating the calibration parameters at step S104 will be described. FIG. 7 is a diagram illustrating a positional relationship between the imaging unit 1 (camera) provided to the vehicle and the calibration index 8. The imaging unit 1 is provided at the rear part of the vehicle, and the mounting position of the imaging unit 1 is represented by a point (tx, ty, tz) in a world coordinate system (Xw, Yw, Zw) as an absolute coordinate. Although a center 0 of an edge of the rear bumper of the vehicle is set to be an origin of the world coordinate system (Xw, Yw, Zw) in an example in FIG. 7, it is needless to say that any point in the space may be set as the origin, provided that positions in the entire system may be defined unambiguously.

In the system having the position of the imaging unit 1 as the origin, a relative positional relationship may be represented by a camera coordinate system (Xc, Yc, Zc). The camera coordinate system (Xc, Yc, Zc) is represented as a relative coordinate system (a literal shift and a rotational shift in the world coordinate system) having the world coordinate (tx, ty, tz) of the imaging unit 1 as the origin. FIG. 8 is a diagram illustrating examples of a rotation in the world coordinate system (Xw, Yw, Zw), and FIGS. 8(a), (b) and (c) illustrate a rotation (pan) about an axis Zw, a rotation (roll) about an axis Yw and a rotation (tilt) about an axis Xw, respectively. When α, β and γ represent a rotation angle of the pan, a rotation angle of the roll and a rotation angle of the tilt, respectively, a relationship between the camera coordinate system (Xc, Yc, Zc) and the world coordinate system (Xw, Yw, Zw) may be represented by the following Formula (1).

$$\begin{matrix}[ Formula 1 ] & \\ [ \begin{matrix}{Xc}_{1} \\ {Yc}_{1} \\ {Zc}_{1} \\ 1\end{matrix} ] = [ \begin{matrix}cos α & - sin α & 0 & 0 \\ sin α & cos α & 0 & 0 \\ 0 & 0 & 1 & 0 \\ 0 & 0 & 0 & 1\end{matrix} ] [ \begin{matrix}cos β & 0 & sin β & 0 \\ 0 & 1 & 0 & 0 \\ - sin β & 0 & cos β & 0 \\ 0 & 0 & 0 & 1\end{matrix} ] [ \begin{matrix}1 & 0 & 0 & 0 \\ 0 & cos γ & - sin γ & 0 \\ 0 & sin γ & cos γ & 0 \\ 0 & 0 & 0 & 1\end{matrix} ] [ \begin{matrix}1 & 0 & 0 & - tx \\ 0 & 1 & 0 & - ty \\ 0 & 0 & 1 & - tz \\ 0 & 0 & 0 & 1\end{matrix} ] [ \begin{matrix}{Xw}_{1} \\ {Yw}_{1} \\ {Zw}_{1} \\ 1\end{matrix} ] & ( 1 )\end{matrix}$$

Here, a relationship between an incident angle θᵢ of the light of a subject on the lens of the imaging unit 1 and an image height y on the image sensor of the imaging unit 1 is defined by the following Formula (2) when, for example, a pinhole lens is employed. In Formula (2), f represents a focal length of the lens.

[Formula 2]

y=f tan θᵢ (2)

The incident angle θᵢ on the lens may be calculated from the following Formula (3).

$$\begin{matrix}[ Formula 3 ] & \\ {θ}_{i} = {tan}^{- 1} \frac{\sqrt{{xc}^{2} + {zc}^{2}}}{yc} & ( 3 )\end{matrix}$$

Based on the image height y, on the other hand, an image coordinate system (xi, yi) is defined by the following Formulas (4), (5) and (6). Here, Xmax and Ymax represent an image size in the vertical direction and in the horizontal direction, respectively, and pix_x and pix_y represent a pixel size of the sensor in the vertical direction and in the horizontal direction, respectively. Since coordinates of the calibration points in the world coordinate system are known, when coordinates of two calibration points A and B on the image is determined by a sequential operation of the instruction unit 5 illustrated in FIG. 6, each of the pan angle, the roll angle and the tilt angle may be calculated from Formulas (1)-(6).

$$\begin{matrix}[ Formula 4 ] & \\ xi = X max / 2 + y cos {φ}_{i} / pix\_x & ( 4 ) \\ yi = Y max / 2 + y sin {φ}_{i} / pix\_y & ( 5 ) \\ {φ}_{i} = {tan}^{- 1} \frac{zc}{xc} & ( 6 )\end{matrix}$$

After the CPU 4 calculates the calibration parameters, the imaging unit 1 outputs the image offset by an amount corresponding to the calibration parameters, or the image superimposing unit 3 sets offset for the superimposed image from the imaging unit 1 by the amount corresponding to the calibration parameters. As a result, the image superimposing unit 3, in generating the superimposed image by superimposing an image such as the predicted track or the like on the digital image generated by the image processing unit 2, superimposes the predicted track or the like offset from its superimposing position prior to calculation of the calibration parameters. Therefore, a highly accurate predicted vehicle track may be displayed in parking, for example.

The camera calibration device according to the present embodiment, as described above, without an complex operation such as repetitive fine adjustments, enables to easily adjust the display positions of the calibration markers 14a and 14b to overlap the two points A and B of the calibration index 8 and to calculate the mounting angle (the pan angle, roll angle and tilt angle) of the imaging unit 1 (camera) for calibration. Especially, since the display positions of the calibration markers 14a and 14b may be adjusted by simply shifting the calibration markers in the vertical and horizontal directions without rotating, the work load imposed on the operator is reduced in operation and easy calibration is enabled.

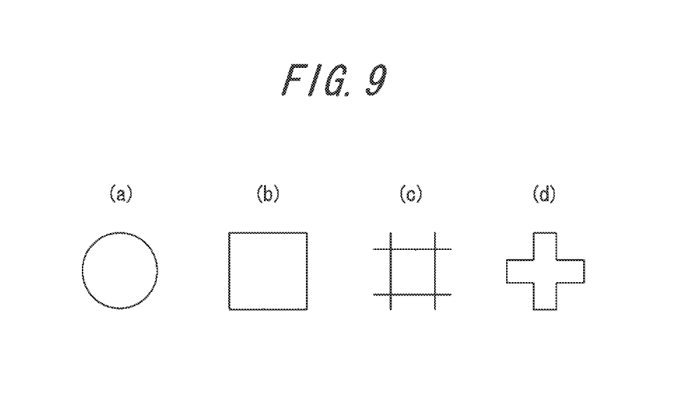

Note that it takes some time to finely adjust the positions of the calibration markers 14a and 14b to meet the ends A and B of the calibration index 8, and also that, when the calibration markers 14a and 14b do not completely meet the ends A and B of the calibration index 8, obtainment of the calibration parameters is not affected. Therefore, it is preferable that the calibration markers 14a and 14b are in the form of a frame surrounding a predetermined area and the CPU 4 obtains the coordinate of the positions of the calibration markers 14a and 14b when the predetermined area surrounded by the calibration markers 14a and 14b accommodate the ends A and B of the calibration index 8. FIG. 9 is a diagram illustrating examples of the calibration marker. Each of the calibration markers illustrated in FIGS. 9(a)-(d) are shaped to surround the predetermined area.

The present invention is applicable to the camera calibration device, for calibration of a camera mounting angle on the movable object by calculating the camera mounting angle by taking an image of the calibration index, the camera and the camera calibration method.

### EXPLANATION OF REFERENCE NUMERALS

1 Imaging Unit
2 Image Processing Unit
3 Image Superimposing Unit
4 CPU (Calculation Unit)
5 Instruction Unit
5a Operation unit
6 Image Output unit
7 Display
8 Calibration Index
9 Start Button
10 Shift Button
11 Position Determination Button
12 Execution Button
14 Calibration Marker
20 Display Panel
21 Rear Bumper
100 Camera Calibration Device
200 Movable Object

What is claimed is:

1. A camera calibration device for calibrating a camera mounting angle on a movable object by calculating the camera mounting angle by taking an image of a calibration index, comprising:
an imaging unit configured to take the image including the calibration index having two separate points on a plane;
an image superimposing unit configured to process an image signal such that a calibration marker is superimposed on the image;
an instruction unit configured to instruct on a position to superimpose the calibration marker in the image; and
a calculation unit configured to calculate the camera mounting angle based on a display position of the calibration marker when the calibration marker is superimposed overlapping the two points of the calibration index.

2. The camera calibration device according to claim 1, wherein the calibration marker is shifted in vertical and horizontal directions.

3. The camera calibration device according to claim 1, wherein two calibration markers are displayed on the image so as to correspond to two separate points of the calibration index and display positions of the calibration markers may be separately controlled by an instruction means.

4. The camera calibration device according to claim 1, wherein the calibration marker is formed of two lines orthogonal to each other and an intersection of the two lines indicates the display position of the calibration marker.

5. The camera calibration device according to claim 1, wherein the calibration marker is in a shape surrounding a predetermined area, and
the calculation unit calculates the camera mounting angle based on the display position of the calibration marker when the calibration marker is displayed overlapping the two points of the calibration index.

6. The camera calibration device according to claim 1, wherein the calibration index is formed of a line connecting the two separate points.

7. The camera calibration device according to claim 1, wherein the image superimposing unit highlights the calibration marker being shifted.

8. The camera calibration device according to claim 1, wherein the image taken by the camera is output, after the calculation unit calculates the parameters, being offset by an amount corresponding to the parameters.

9. The camera calibration device according to claim 1, wherein the image superimposing unit, when superimposing a predetermined image on the image taken by the camera, sets an offset for a superimposing position by the amount corresponding to the parameters.

10. The camera calibration device according to claim 1, further comprising a display for displaying an image in which the calibration marker is superimposed on the image including the calibration index.

11. A camera calibration device for calibrating a camera mounting angle on a movable object by calculating the camera mounting angle by taking an image of a calibration index, comprising:
an image superimposing unit configured to process an image signal such that a calibration marker is superimposed on the image including the calibration index having two separate points on a plane;
an instruction unit configured to instruct on a display position of the calibration marker superimposed on the image; and
a calculation unit configured to calculate the camera mounting angle based on the display position of the calibration marker when the calibration marker is superimposed overlapping the two points of the calibration index.

12. A camera calibration method for calibrating a camera mounting angle on a movable object by calculating the mounting angle by taking an image of a calibration index, comprising:
a step to take an image including the calibration index having two separate points on a plane;
a step to superimpose a calibration marker on the image;
a step to instruct on a display position of the calibration marker superimposed on the image; and
a step to calculate the camera mounting angle based on the display position of the calibration marker superimposed overlapping the two points of the calibration index.

13. A camera capable of calibrating a camera mounting angle on a movable object by calculating the camera mounting angle by taking an image of a calibration index, comprising:
an imaging unit configured to take an image including the calibration index having two separate points on a plane;
an image superimposing unit configured to process an image signal such that a calibration marker is superimposed on the image;
an instruction reception unit configured to receive an instruction on a display position of the calibration marker superimposed on the image; and
a calculation unit configured to calculate the camera mounting angle based on the display position of the calibration marker superimposed overlapping the two points of the calibration index.
